(19) United States
(12) Patent Application Publication
(10) Pub. No.: US 2009/0046775 A1
(43) Pub. Date: Feb. 19, 2009

(54) System And Method For Delivery Of Electronic Data

(76) Inventors: Arvind Thiagarajan, Besant Nagar (IN); Shlvakumar Karathozuvu Narayanan, Thiruvanmlyur (IN); Sunil Mukundan, Thiruvanmiyur (IN); Chandramouli Namasivayam, Choolailaimedu (IN); Jaisimha Ravilla, Tiruttani (IN); Yuvaraj Karumanchi Munirathnam, Nagar Nandanam (IN); Ganesan Rajakani, Old Washermenpet (IN); Elziq Yacoub, Saratoga (IN)

Correspondence Address: SQUIRE, SANDERS & DEMPSEY L.L.P., 1 MARITIME PLAZA, SUITE 300, SAN FRANCISCO, CA, 94111, US

(21) Appl. No.: 12/192,845

(22) Filed: Aug. 15, 2008

Related U.S. Application Data
(60) Provisional application No. 60/965,156, filed on Aug. 17, 2007.

(51) Int. Cl. H04B 1/66

(52) U.S. Cl. 375/240; 375/E07.001

(57) ABSTRACT

System and method for compressing data with the use of an Adaptive Progression Pattern and/or Logical Frequency Lexicon. The system and method may also comprise a adaptive learning scheme to update the Adaptive Progression Pattern and/or Logical Frequency Lexicon.

### CROSS-REFERENCE TO RELATED APPLICATIONS

This application claims the benefit of U.S. Provisional Application No. 60/965,156, filed Aug. 17, 2007.

### FIELD OF THE INVENTION

The present disclosure relates generally to compression of data to improve the speed of data delivery and the efficiency of data storage. More specifically, compressing data according to data type in consideration, also, of other criteria.

### BACKGROUND

Web search effectiveness has always been a game of better ranks of search results, clustering of search results, and identifying human intention of the search keyword and tagging relevance of the search query to the generated results.

Therefore, a need exists to increase the speed by which a search engine is able to get search results to a client. Need also exists for transmitting web content to clients. Further need exists to compress various types of data for transmission and/or storage.

### SUMMARY OF THE DESCRIPTION

These and other aspects of the present invention will become more apparent to those skilled in the art from the following non-limiting detailed description of exemplary embodiments taken with reference to the accompanying figures.

In accordance with an exemplary embodiment of the present invention a system and method are provided to increase the speed of delivery of search results to a user. In accordance with another embodiment of the present invention, the speed of delivery of search results are increased by compressing data differently according to the category of data.

In accordance with an example of an exemplary embodiment of the present invention, Adaptive Progression Patterns (APP) are used to compress hybrid data files in a more efficient manner. In accordance with another example of an exemplary embodiment of the present invention, the APP is updated with the use of an adaptive learning scheme and/or an update mechanism.

### BRIEF DESCRIPTION OF THE DRAWINGS

The disclosure is illustrated by way of example and not limitation in the figures of the accompanying drawings in which like references indicate similar elements.

FIG. 1 illustrates an example of a server in accordance with an exemplary embodiment of the present invention.

FIG. 2 illustrates an example of an initializer in accordance with an exemplary embodiment of the present invention.

FIG. 3 illustrates an example of a data analyzer in accordance with an exemplary embodiment of the present invention.

FIG. 4 illustrates an example of a protocol decision logic in accordance with an exemplary embodiment of the present invention.

FIG. 5 illustrates an example of a compression decision logic in accordance with an exemplary embodiment of the present invention.

FIG. 6 illustrates an example of a compression module in accordance with an exemplary embodiment of the present invention.

FIG. 7 illustrates an example of an adaptive learning scheme in accordance with an exemplary embodiment of the present invention.

FIG. 8 illustrates an example of an update mechanism in accordance with an exemplary embodiment of the present invention.

FIG. 9 illustrates an example of a client in accordance with an exemplary embodiment of the present invention.

FIG. 10 illustrates a diagram of a system for delivering electronic data in accordance with an exemplary embodiment of the present invention.

FIG. 11 illustrates a diagram of the system of FIG. 10, showing a adaptive learning module, decoder, and encoder.

FIG. 12 illustrates a diagram of another system for delivering electronic data in accordance with an exemplary embodiment of the present invention.

FIGS. 13A-13D illustrate graphs of download times of the system of FIG. 12.

### DETAILED DESCRIPTION

The following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be, but not necessarily are, references to the same embodiment; and, such references mean at least one.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Exemplary embodiments of the present invention may use data compression to increase the delivery rate of data and/or search results of a web search. Another embodiment of the prevent invention includes email acceleration—MIME/HTML email acceleration with content adaptive approach. (Emails are mostly MIME/HTML compliant with the HTML based presentation and MIME for content. The same concept used for search pages can be used for email. The presentation layer for all emails is almost the same and the content changes dynamically from user to user. This is analogous to web search results. Similar constraints such as real time delivery exist even for emails.) Yet another embodiment includes accelerating dynamic content for Web/Application Servers, such as, for example, IBM Web Sphere, Wordpress, etc. Portals, Blogs, Web 2.0 sites, and other content management systems all fall under this category, since dynamic content creation coupled with fixed presentation styles is a feature of all these applications.

In other embodiments of the present invention the data compression may be content specific and may also be sensitive to the size and/or distribution of the search results.

In yet further exemplary embodiments of the present invention, content is differentiated at a binary level in order to classify and trigger the best compression mechanism for the data presented. Particularly, the content may be analyzed and, therefore, the compression level may be changed and the speed of the optimized transmission may be adjusted. For example, according to aspects of exemplary embodiments of the present invention the level of compression of data may be adjusted based on the size of the data and available client bandwidth.

In further embodiments of the present invention the performance of the compression may be increased with adaptive learning techniques to update the system.

An exemplary embodiment of the present invention may comprise both client and server components. An example of an exemplary server component according to the present invention may comprise the following modules: an initializer, a data analyzer, protocol decision logic, compression decision logic, compression module, an adaptive learning scheme, and an update mechanism. An example of an exemplary client component according to the present invention may comprise the following modules: a header analyzer, decompression decision logic, a decompression module, and a delivery module.

Various aspects of exemplary embodiments of the present invention are disclosed in greater detail below.

I. Server

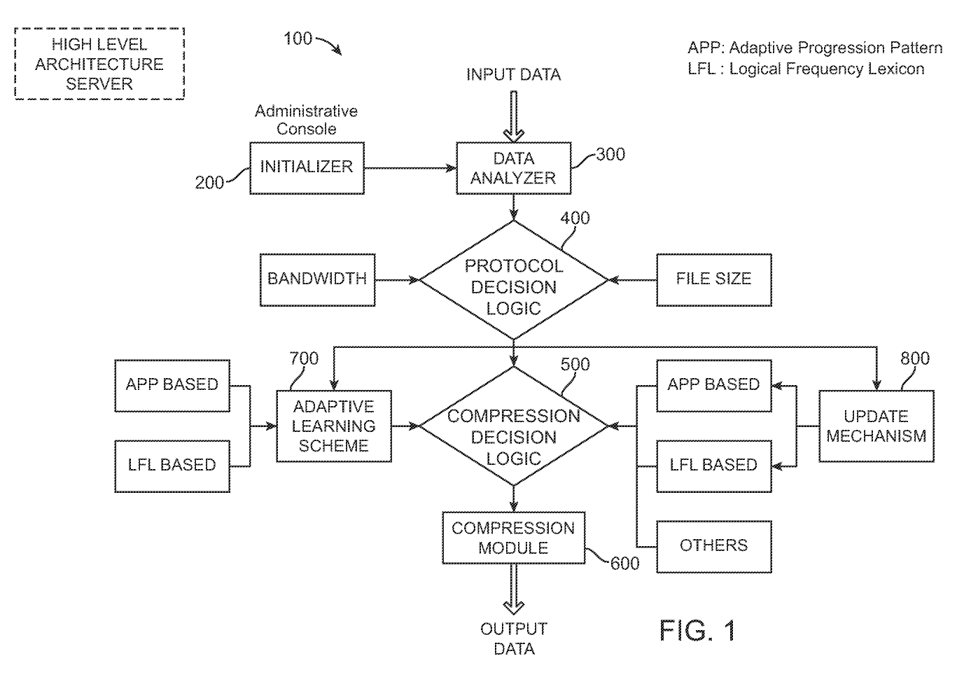

FIG. 1 depicts an example of various possible components of a server 100 in an exemplary embodiment of the present invention. Components of a server according to aspects of some embodiments of the present invention may comprise, but are not limited to, an initializer 200, a data analyzer 300, a protocol decision logic 400, a compression decision logic 500, a compression module 600, an adaptive learning scheme 700, and an update mechanism 800.

A. Initializer

The initializer 200 may comprise an administrative console that may allow the administrator to select the default compression settings and target area settings. Examples of target areas may comprise, but are not limited to, web content, email, content management systems, and web 2.0.

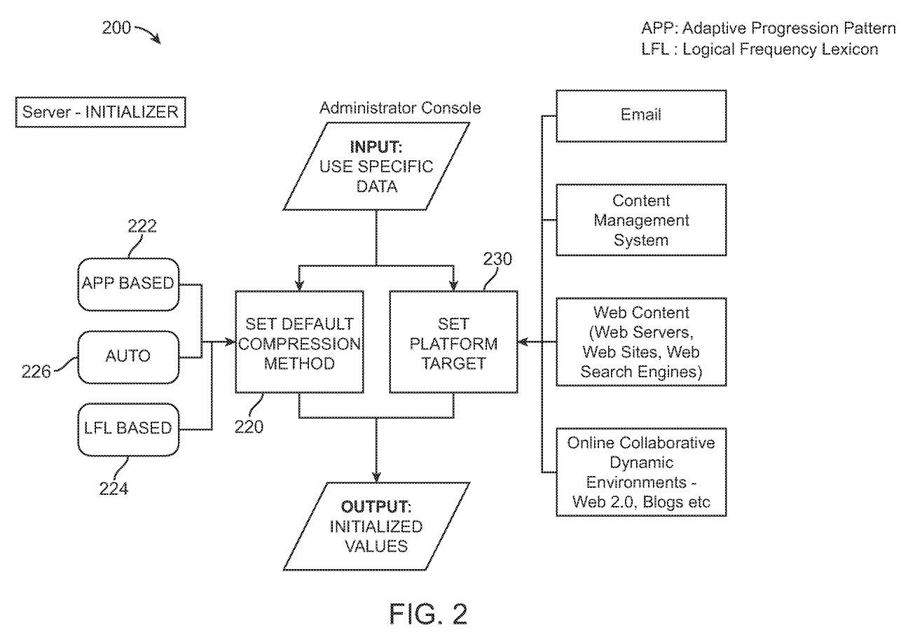

FIG. 2 illustrates an exemplary embodiment of an initializer 200 in accordance with an embodiment of the present invention. With continuing reference to FIG. 2, the administrator of the system may set the default compression method, as depicted in box 220. As an example, the administrator may choose to have an Adaptive Progression Patterns (APP) Method based compression 222, a Logical Frequency Lexicon (LFL) Method based compression 224, or an auto mode 226. It should be noted, however, that this is not an exhaustive list of possible compression modes, as any compression mode known may be chosen by the administrator.

If APP mode 222 is chosen, the APP based compression engine is used by the compression module. Likewise, if the LFL method 224 is selected, the LFL based compression engine is used by the compression module. If the auto method 226 is chosen, a system according to aspects of an exemplary embodiment of the present invention may choose between the APP mode 222, the LFL mode 224, or a combination of both. In another embodiment of the present invention, the incoming data will determine what mode will be used when auto mode 226 is chosen. In yet another embodiment of the present invention, the system will automatically choose what mode will be used when auto mode is selected.

As depicted in box 230, the administrator may be able to set the platform target for the server that hosts server 100. A selection in this box may allow the engine to have apriori information on the target, and may allow the engine to therefore make its internal module selections for compression appropriately.

B. Data Analyzer

The data analyzer 300 may analyze the input data based on parameters. Examples of such parameter include, but are not limited to, the distribution and the content. The analyzer 300 may also classify the data into different classes.

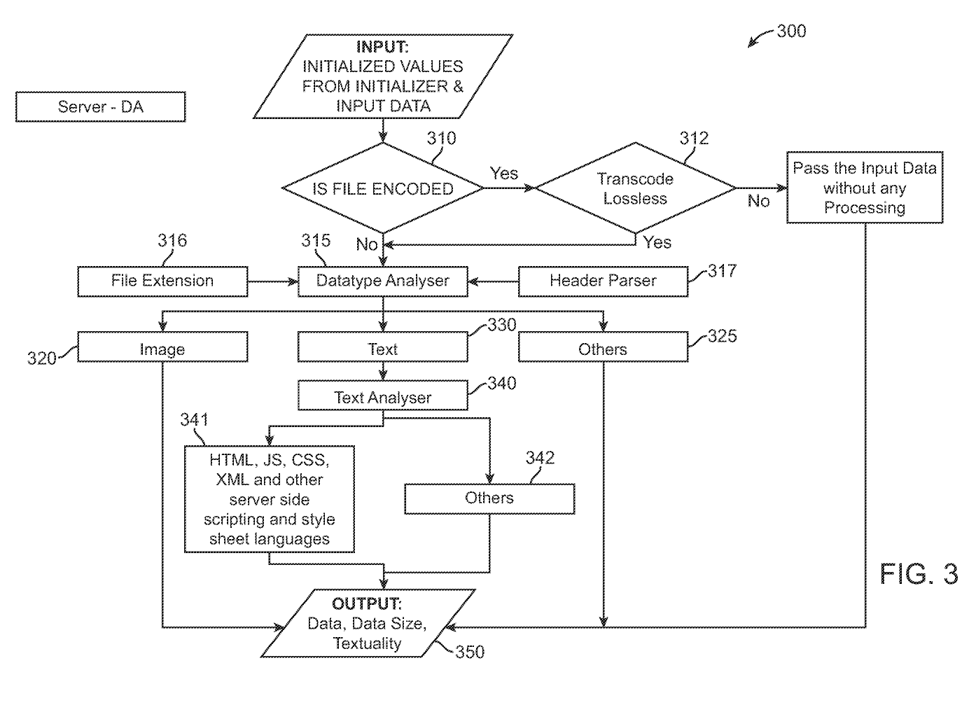

FIG. 3 depicts an exemplary embodiment of data analyzer 300 in accordance with aspects of the present invention. The data analyzer 300 may receive information from the initializer 200 and the input data.

The data analyzer may then determine whether a file is encoded, as can be seen in box 310. Some data that enters the analyzer 300 may already be encoded. Examples of such data includes, but is not limited to, uuencode, base 64, and some zipped files.

Files that are already encoded may pass to box 312, wherein the data analyzer 300 determines whether the file can be transcoded (converted from one encoded format to another). Those files that can't be transcoded 314 may pass to the output stream 350. In accordance to one exemplary embodiment of the present invention, the files that can't be transcoded 314 are passed directly to the output stream 350 without any further analysis.

Files that can be transcoded, along with files that are not encoded, then pass to the datatype analyzer 315. The datatype analyzer 315 may divide the incoming data files into separate categories, depending on the type of data contained in the file. For example, the data analyzer 315 may divide the files into image files 320, text files 330, and other files 325. It should be noted that other division of files may be used. The datatype analyzer 315 may use information from the file extension 316 and the header parser 317 to determine into which category to put the file.

In an exemplary embodiment of the present invention, image files 320 and other files 325 are passed to the output stream 350. In another exemplary embodiment, the image files 320 and the other files 325 are passed to the outlet stream 350 without any further analysis. On the other hand, files that are categorized as text 330 may be sent to the text analyzer 340.

The text analyzer 340 may analyze the content of the files and calculate the “textuality” of the file. The textuality of the file may be defined as to whether the text is html, javascript, css, xml and other server scripting/style sheet languages, or any other text language, either now know or hereinafter developed.

In an exemplary embodiment of the present invention, once the text analyzer 340 has analyzed the text, the file is categorized according to the textuality. For example, server side scripting, style sheet language, and html may be categorized as hybrid content 341 that is generated dynamically by web search engines. All other may be categorized as an others category 342.

Upon being categorized by the text analyzer 340, the files are sent to the output stream 350. According to an exemplary embodiment of the present invention, the output stream 350 of the data analyzer 300 may comprise the data, the size of the data, and the textuality.

C. Protocol Decision Logic

The protocol decision logic 400 makes decisions based on a variety of parameters. In one embodiment of the present invention, the protocol decision logic 400 will make decisions based on the size of the data and the available bandwidth of the client. In accordance with aspects of an exemplary embodiment of the present invention, the protocol design logic 400 may adjust important compression parameters according to the bandwidth and data size. As an example, the protocol decision logic may adjust the compression performance and the speed of the compression.

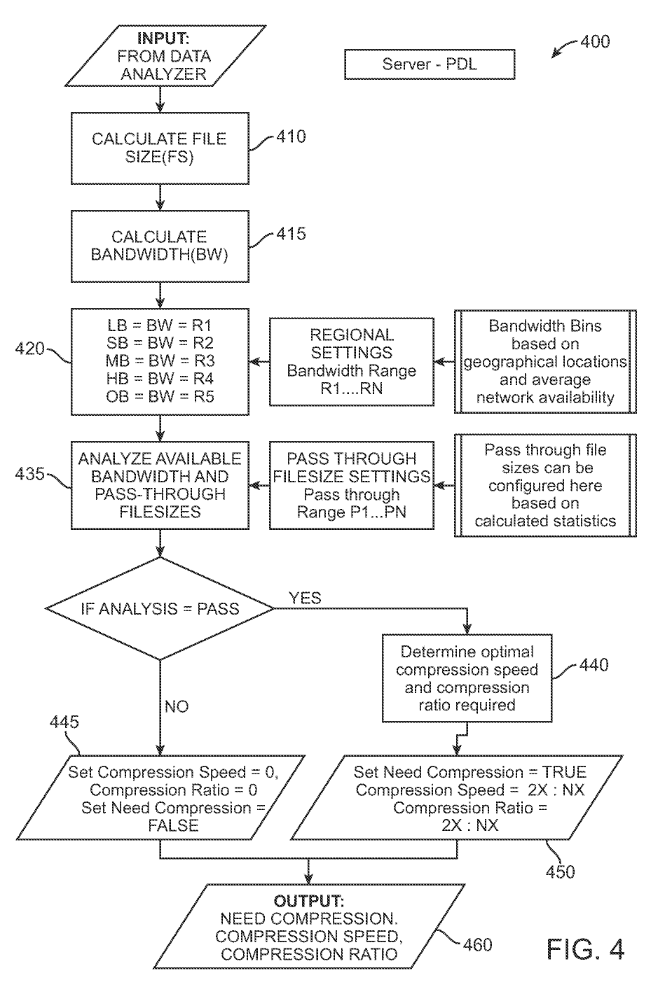

FIG. 4 illustrates an example of an exemplary embodiment of the protocol decision logic 400. Initially, the file size and bandwidth available to client is calculated by the protocol decision logic 400. For example, the bandwidth may be calculated, as depicted in block 415, using the common ping operation and calculating the round trip time for test data packets that are sent to the client. The file size may be calculated, as depicted in block 410, through normal system functions, either now known or hereinafter developed. It should be noted that any method may be used to calculate the bandwidth and/or the file size.

With continued reference to FIG. 4, block 420 may represent configurable options set by the administrator to help determine whether compression may be needed or not. For example, the administrator may be able to set the “pass through file size”, which refers to size of file for which compression will not be done. In accordance with an exemplary embodiment of the present invention, the “pass through file size” may be the size of a file in which compression of the file would not be beneficial. For example, the gain in compression savings and throughput gain is likely to be less than the overhead in compression and decompression time. Therefore, it may be more beneficial in terms of overhead to allow such files to pass without compression.

In accordance with an exemplary embodiment of the present invention, the “pass through file size” may be determined at least in part by bandwidth available. The administrator may be able to set bandwidth ranges that vary from region to region. In addition the bandwidth ranges may also be chosen based on the average network availability in a particular geographic area.

Block 435, represents the analysis of whether compression is needed. In accordance with an exemplary embodiment of the present invention, both the available bandwidth and file size may be evaluated to determine whether a compression should be done, or whether the data should be send through without a compression.

If it is determined that no compression is necessary, the compression speed may be set to 0, the compression ratio may be set to 0, and the need for compression is set to FALSE. This is depicted in block 445.

On the other hand, if it is determined that a compression is to take place, the optimal compression ratio and compression speed that would deliver the improved throughput is determined, as depicted in block 440.

Any data optimization process, for example, compression and decompression, may contribute an overhead (Cₜ and Dₜ) to the round trip time. In scenarios when the data is at rest (i.e., archival, storage, etc.) the overhead due to data optimization may be neglected, however, in cases where transmission is involved, the overhead due to optimization should not offset the data optimization gains. For example:

Let T′ₜ=Sc/B, where Sc is the compressed data size and T′ₜ is the transmission time for the compressed data.

Then the gain in transmission time (G) may be represented as:

G=T′ₜ−Tₜ=(S−Sc)/B sec

The overhead due to the compression process (O) may be represented as:

O=Cₜ+Dₜ sec

Therefore the critical condition for success of the optimization process may be given as:

G≧0,

or alternatively:

G−O≧0.

Therefore, the gain due to transmission should be at least equal to the overhead due to the optimization process. Preferably, the compression mode that maximizes G−O should be chosen.

Once the correct compression mode is selected, block 450 may set the need to compression to TRUE, set the compression speed, and set the compression ratio.

The output 460 is whether compression is needed, the compression speed, and the compression ratio.

D. Compression Decision Logic

The compression decision logic 500 may substantiate the need for compression. In an exemplary embodiment of the present invention, the compression decision logic may make choices on how data is coded. In an example of an exemplary embodiment of the present invention, the compression decision logic decides whether the data falls under APP (i.e., adaptively acquired information can be used to encode). In another example of an exemplary embodiment of the present invention, the data can be coded based on LFL according to the nature of the data. In yet another example, other generic algorithms may be used to code the data.

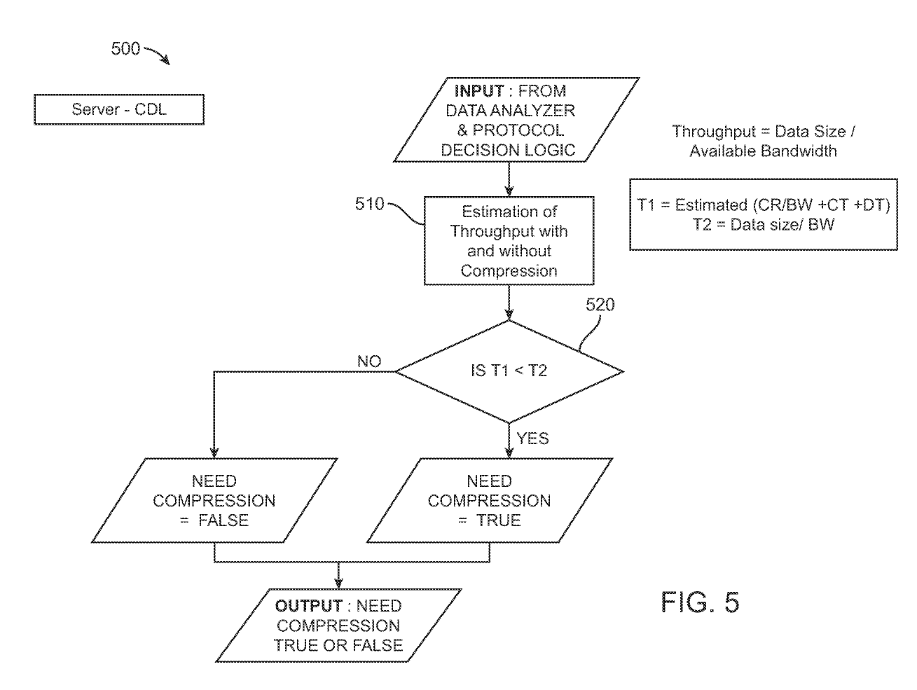

With reference to FIG. 5, which illustrates an exemplary embodiment of the compression decision logic 500, block 510 may calculate an estimate of throughput of files with compression and without compression. An estimate of throughput time with compression would be as follows:

T1=(CR/BW+CT+DT),

where CR is the compression ratio or data size, CT is the compression time and DT is the decompression time. Average compression ratios may be used as a reference in this estimation. The estimation of throughput without compression is as follows:

T2=Data Size/BW.

Block 520 determines whether T1 or T2 is greater. If T1 is less than T2 the need for compression may be established.

The compression decision logic may differ from the protocol decision logic in the following ways: the protocol decision logic may take into consideration of the various ranges of bandwidth available and makes an estimate of the throughputs that will be required for improved data throughput, whereas the compression decision logic determines whether compression may be needed for a throughput difference. It should be noted that, according to exemplary embodiments of the present invention, the output from both the protocol decision logic and the compression decision logic may be required for the compression module.

E. Compression Module

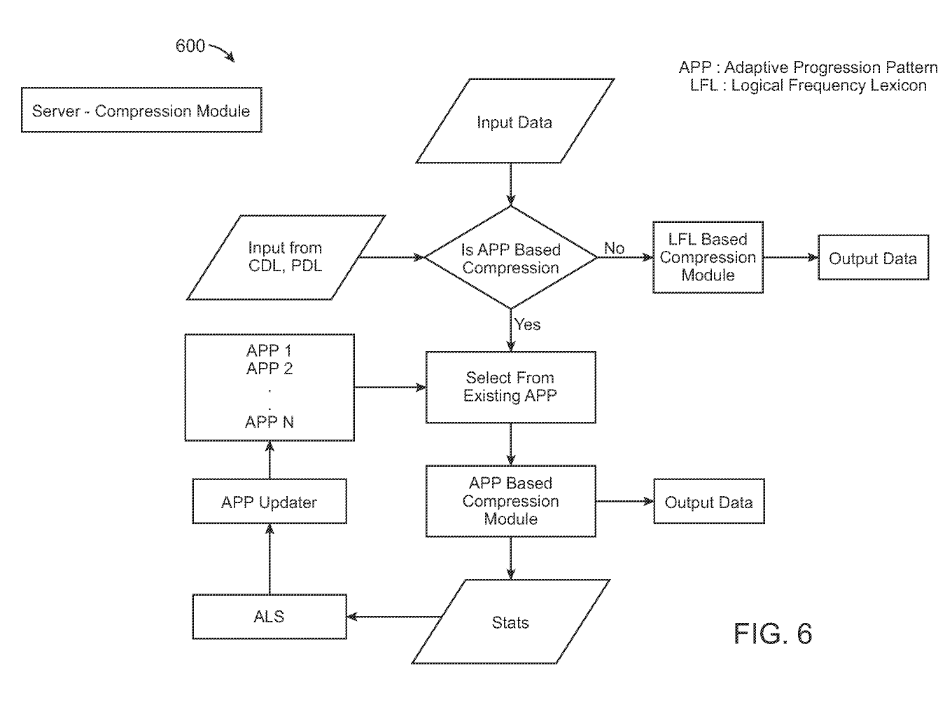

FIG. 6 depicts an exemplary embodiment of the compression module in accordance with aspects of an embodiment of the present invention. In accordance with aspects of an exemplary embodiment, the Compression Module is a multi-faceted compression platform. Some of the forms of compression are based on APP and LFL. The compression scheme is selected based on, at least in part, the input from the Protocol Decision Logic and the Compression Decision Logic. In another embodiment of the present invention, the compression module may be fed with information and/or statistics to maintain its performance edge. In one embodiment, the compression module may be continuously fed with information and/or statistics. Furthermore, the Adaptive Learning Scheme 700 may provide the compression module with intelligence.

In accordance with an exemplary embodiment of the present invention, the compression module receives the following inputs from the protocol decision logic 400 and the compression decision logic 500: a flag indicating whether compression is required, and if it is required, the compression speed and compression performance requirements. This is depicted in block 605.

In accordance with aspects of the present invention, the compression algorithm is a sequence of several blocks. Multiple such sequences exist. The compression speed and compression performance may be adjusted by choosing the right sequence first and then turning on/off appropriate blocks. The intelligence regarding choosing the sequence and blocks may be hardwired into the system. Some of the key parameters based on which the blocks/sequence are chosen may include, but are not limited to, entropy of the data, nature of data and size of each data element. Highly entropy data may be unlikely to be compressed very efficiently. Extremely simple coding logic is chosen in this case.

Once the compression sequence and blocks are chosen, the APP/LFL are loaded based on whether the data is static, dynamic, homogenous or hybrid. The compressed data is then transmitted to the client.

According to an embodiment of the present invention, statistics are monitored and/or saved. This monitoring may be done continuously. Furthermore, the statistics are sent to the Adaptive Learning Scheme 700 as an input. According to aspects of an exemplary embodiment, the Adaptive Learning Scheme will generate the appropriate APP and/or LFL according to the statistics. Meanwhile the Update Mechanism may update the APP and/or LFL for further compression.

According to aspects of the present invention, statistics may include, but are not limited to, compression ratio and trends in compression performance for various categories of input data. The history of compression of data may be monitored.

In another embodiment of the present invention, a multi-threaded environment may exist. The thread (Master Thread) that monitors the statistics can be set. Other threads are the Slave Threads. In the case of an updated APP and/or LFL, the Master Thread will get the updates and will set the flag of the current flag to it unique new ID.

In one embodiment, the Slave Threads will check for updated APP and/or LFL by checking for updates with the Master Thread. In another embodiment, the Slave Threads will constantly check for updated APP and/or LFL. This allows the Slave Threads to get notification of updates and start using the updated APP and/or LFL.

F. Adaptive Learning Scheme

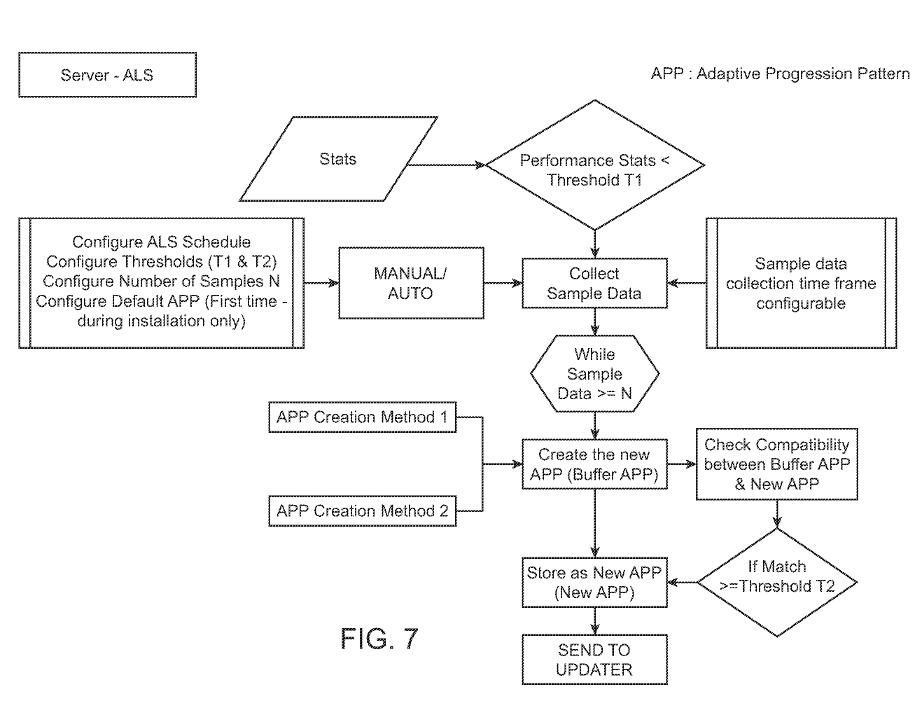

The Adaptive Learning Scheme 700 reflects the learning of the compression algorithm. As the compression algorithm encounters more data, the algorithm may learn more. The Adaptive Learning Scheme adaptively creates a new APP and/or LFL with the help of a sample set. An exemplary embodiment of the adaptive learning scheme is depicted in FIG. 7.

In one embodiment, the Adaptive Learning Scheme runs perpetually in a wait mode. However, the Adaptive Learning Scheme can be run in any other mode, such as, for example, a continually active mode.

According to one embodiment, an event will turn the Active Learning Scheme to active mode. An example of such an event is a scheduled learn event, such as, for example, when performance statistics falls below a certain threshold the learning mode is triggered. In one embodiment, a multi-threaded scenario where multiple files are being compressed, a Master Thread does the monitoring of statistics. Hence, the input to the Active Learning Scheme will be obtained from the master thread in this case.

Although, there are numerous ways to create new APP and/or LFL, two example of exemplary embodiments are given

Creation Method 1:

Two sample files are considered as H1 and H2.

The files are refined based on common tag information and other information that is common to both the files. This refined sample is H3.

This process is iteratively carried out for N samples, where the previous H3 is renamed as H1 and the new sample is taken as H2.

Additional frequently used tags and words are added to the end.

The recursive process is stopped when the incremental delta (in accuracy or changes to the new APP) saturates.

Creation Method 2:

In this method, N collected samples are taken.

In each sample, the common tag information and hypertexts are removed.

From the remaining samples, the redundant and recurring words are removed, thereby leaving the samples with only unique words.

These samples are then matched with a Master Natural Language LFL to create a ranking based on the number of words matched and their ranking based on the level and position of match.

This matching and ranking is done for all the samples which have unique words at the end of the refinement process.

The sample which has the highest ranking is assigned as the ‘New APP’.

Once a new APP is created, it is compared to the existing APP. A simple XOR/WXOR (Weighted XOR) is used to estimate the similarity. The match will be a weighted average of all these estimates and denoted as a percentage match of the current APP. This estimated match is then compared with a fixed threshold. The current APP may need to be updated if the estimated match is greater than the threshold. By checking the estimated match with a fixed threshold, the Adaptive Learning Scheme will deliver an update that was not triggered by a false positive (e.g., a small set of random set of files that caused the compression to fall below the acceptable levels and thereby trigger learning).

It should be noted, that a new LFL can be created using a similar process. The difference is that the set of N samples is aggregated and the LFL is created from the sum of these files, whereas in the APP method each sample is used to create the APP and then iteratively checked with the entire sample set collected until a unique APP is determined.

The new APP and/or LFL is now used for compression of all dynamically generated data whenever the APP and/or LFL method is used. The old APP and/or LFL will be maintained for a pre-determined time frame before they are deleted. The client, however, may be programmed to have only the latest APP and/or LFL at any point of time.

In one embodiment of the present invention, the Adaptive Learning Scheme can be in AUTO or MANUAL modes. In Auto mode the Adaptive Learning Scheme learns adaptively based on the performance statistics. In MANUAL mode the Adaptive Learning Scheme is triggered with the manual input from the administrator.

In another embodiment of the present invention, the system uses a combination of both APP and LFL compression methods in situations that can make the best of the both compression methods. Such situations are determined by monitoring the performances statistics, trends, progression, and other aspects of the input data.

G. Update Mechanism

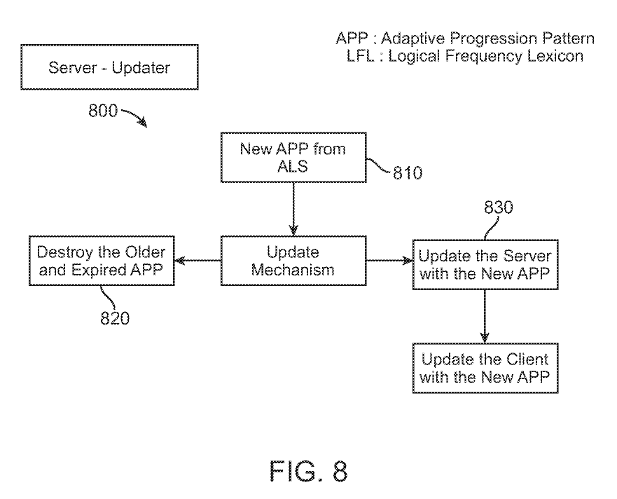

The update mechanism 800 may ensure that the client 900 and server 100 are synchronized and at the same state. An exemplary embodiment of the update mechanism in accordance with the present invention is illustrated in FIG. 8.

With reference to FIG. 8, whenever there is a new APP and/or LFL from the Adaptive Learning Scheme 700, as depicted by block 810, the update mechanism 800 will destroy the older and/or expired APP and/or LFL, as depicted by block 820, and updates the server with the new APP and/or LFL, as depicted in block 830. In addition, the update mechanism 800 at the server side may intimate the client the new APP and/or LFL availability and may replace the old APP and/or LFL with the new. This process likewise is carried out for updates on dictionaries.

II. Client

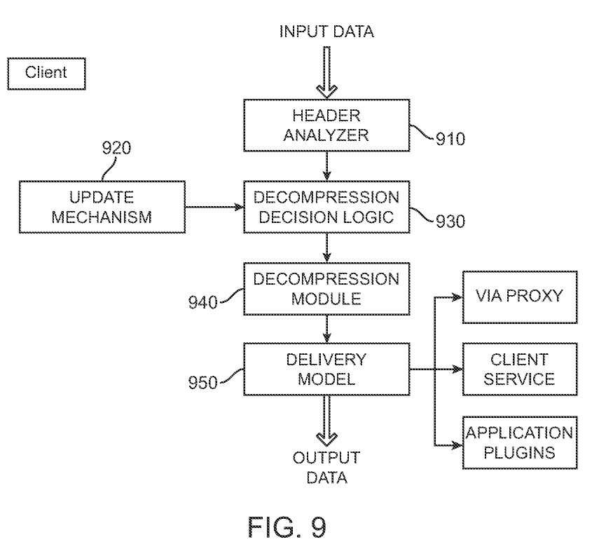

An exemplary embodiment of a client according to aspects of an embodiment of the present invention is depicted in FIG. 9. With reference to FIG. 9, a client may comprise a header analyzer 910, a client update mechanism 920, a decompression decision logic 930, a decompression module 940, and a delivery model 950.

The header of the compressed file that is received at the client end is may be analyzed by the header analyzer 910 for parameters such as, for example, the compression mode and the target area. Based on the above parameters, the decompression decision logic 930 will pass the compressed data to the appropriate decompression module 940.

The decompression module has the information regarding the APP and/or LFL used from the analysis. Accordingly, the correct APP and/or LFL may be loaded and the data is decompressed.

The client is a thin client that is designed to be part of any delivery model as may be required by the end target device.

In the case of web search results being delivered to a browser, the client may be as a client service in a client mode, or, alternatively, as a browser plug-in in a client less mode.

The client update mechanism 920 may be used to update the client with new APP and/or LFL. The client update mechanism 920 is controlled by the server and can be triggered either through update messages or automatic updates. In another embodiment, the updated APP and/or LFL will be detected by their unique ID's in the compressed file header. The client, upon detecting a new ID for the APP and/or LFL, will send a request for the new APP and/or LFL to the server.

III. System for Electronic Delivery of Data

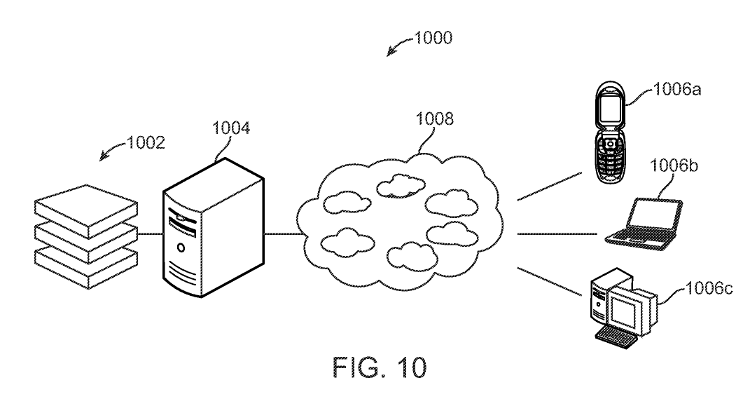

FIG. 10 shows a system 1000 for electronic delivery of data involving a codec. The system includes content servers 1002 and an encoding server 1004 that are linked to various client devices 1006 via a communications network 1008. Examples of client devices include without limitation personal computers (PCs), laptops, mobile telephones, personal digital assistants, and other mobile communication devices.

The invention can be implemented over any type of communications network 1008. Examples include, but are not limited to, the Internet, a local area network (LAN), a wide area network (WAN), a metropolitan-area network (MAN), and direct computer connections. The network 1008 may use any type of communication hardware and protocol.

In some embodiments, the content servers 1002 function as a web server or a search engine server. In some embodiments, the encoding server 1004 receives requests from the client devices 1006, forwards the client requests to the content servers 1002 and responds to the client requests with responses from the content server 1002. A non-limiting example of a request from the client devices 1006 is a search query. A non-limiting example of a response from the content server 1002 is a search result in the form of a web page.

In FIG. 10, the content servers 1002 are shown as multiple servers or devices. In some embodiments, the multiple servers can be referred to as a server farm. In some embodiments, the encoding server is part of the server farm. The encoding server is a personal computer in some embodiments. In some embodiments, the multiple content servers 1002 and the encoding server 1004 are geographically dispersed. In other embodiments, the content servers 1002 and the encoding server 1004 are at the same geographic location. The content servers 1002 and the encoding server 1004 may be interconnected using a LAN connection, a WAN connection, a MAN connection, some form of direct connection, or combinations thereof.

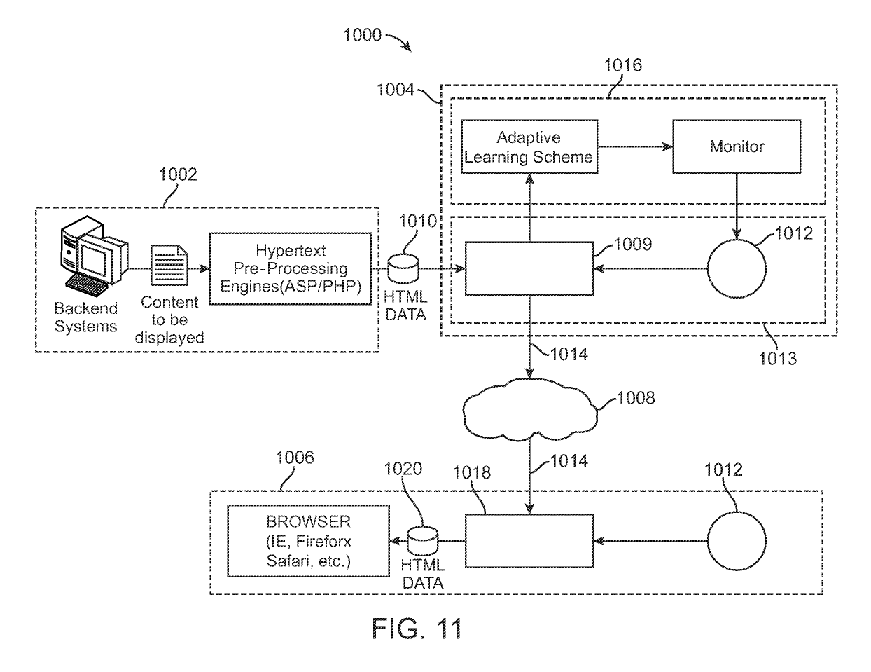

Referring to FIGS. 10 and 11, the encoding server 1004 includes a first codec component or an encoder 1009 adapted to receive input data 1010 from the content servers 1002 and compress the input data according to a model 1012, such as an adaptive progression pattern and/or a logical frequency lexicon. The encoding server 1004 generates delivery data 1014 from the compressed data. In some embodiments, the encoder 1009 is a discrete device that is part of the encoding server 1004. In other embodiments, the encoder 1009 is a software program that is running on the encoding server 1004.

The encoding server 1004 includes an adaptive learning module 1016 that is adapted to modify the model 1012. In some embodiments, the encoding server 1004 is further adapted to compress the input data 1010 using a compression engine 1013 containing the model 1012. Updating the model 1012 causes the compression engine to be updated. In some embodiments, the model 1012 includes an adaptive progression pattern, a logical frequency lexicon, or a combination thereof.

In some embodiments, the encoding server 1004 includes a data analyzer 300 (FIG. 1) adapted to identify data elements of the input data 1010 and determine a characteristic of the data elements. Examples of a characteristics include, without limitation, whether the data element is encoded, whether the data element is capable of being transcoded, whether the data element is text, whether the data element is static, whether the data element is dynamically generated, whether the data element is hybrid content such as a web page returned by a search engine in response to a search query, whether the data element is of a homogenous type, and combinations thereof.

Data elements capable of being transcoded are those that are already in a compressed state. The original compression scheme that was use may be inefficient and it may be possible to compress the data element further to a smaller file size or greater compression ratio. In some embodiments, the encoding server 1004 transcodes data elements by first decoding them, followed by recoding using another compression scheme that is more effective in reducing file size than the original compression scheme. In other embodiments, the encoding server 1004 transcodes a data element to a smaller file size directly without having to first decode the data element.

Referring to FIG. 11, the client device 1006 includes a second codec component or a decoder 1018 adapted to receive the delivery data 1014 from the encoding server 1004. The decoder 1018 decompresses the received delivery data in accordance with the model 1012 and generates output data 1020 from the decompressed delivery data. The model may be stored in a cache or other memory device in the client device 1006.

In some embodiments, the decoder 1018 can be a plug-in residing in the client device 1006 and adapted to interact with a web browser, graphics software, e-mail client, media player, or other host component running on the client device 1006. The delivery data 1014 may include header information indicates a need for the decoder 1018 to allow for proper decompression. A component in the client device 1006, such as a web browser, may analyze the header information and search the client device 1006 for the decoder 1018. If the decoder 1018 is not found, web browser may send a message to the encoding server 1004 or content servers 1002. In response, the encoding server 1004 or the content servers 1002 may send the decoder 1018 to the client device 1006.

In other embodiments, the decoder 1018 is discrete device that physically connects to or is in electronic communication with the client device 1006. In yet other embodiments, the decoder 1018 is a device that resides in the client device 1006.

In other embodiments, the client device 1006 does not have the model 1012 or has an outdated version of the model 1012 when the delivery data 1014 is received. In some embodiments, the delivery data 1014 may include header information that identifies the appropriate model to be used for decompressing. The decoder 1018 may analyze the header information and search the client device 1006 for the appropriate model. If the appropriate model is not found, the decoder 1018 may request it from the encoding server 1004. The encoding server 1004 then sends a copy of the appropriate model to the client device 1006. Upon receipt, the client device 1006 in some embodiments deletes any outdated models.

### TEST EXAMPLE 1

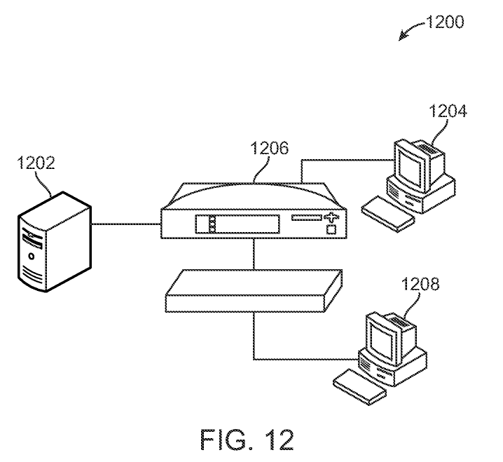

Search strings were collected from the Google Hot Trends listing of 100 most popular over a two-week period and distilled to over 1,000 unique search strings. The search strings were input into AOL, Ask, Google, MSN, and Yahoo search engines and the web page containing the search results were saved as an HTM file. 1,016 HTM files per search engine were stored on a web server 1202 on a test bed 1200, as shown in FIG. 12. The test bed 1200 was separated from the live Internet.

A client PC 1204 was installed with Windows XP professional Service Pack 2 and a client-side component including a decoder of the present invention. The web server 1202 was installed with Windows Server 2003, R2 Service Pack 2 and a proxy server component. The proxy server component included an encoder and adaptive learning module of the present invention.

On the client PC 1204, a web browser's request for a specific web page was relayed to the proxy server component installed on the web server 1202. The proxy server component retrieved the web page from a file cache in the web server and compressed it according to the present invention.

The compressed web page file was transmitted over a simulated WAN link between the client PC and the proxy server. The WAN link was simulated using an Ethernet network simulator 1206, specifically a GEM Advanced Ethernet Network Simulator from Anue Systems Inc., of Austin, Tex. The decoder in the client-side component decompressed the received file and delivered it to the PC's web browser for display.

The client PC 1204 was running HttpWatch Professional Edition v.5.1.23 software from Simtec Limited of Bristol, United Kingdom. The HttpWatch software was used to measure the time to load each web page.

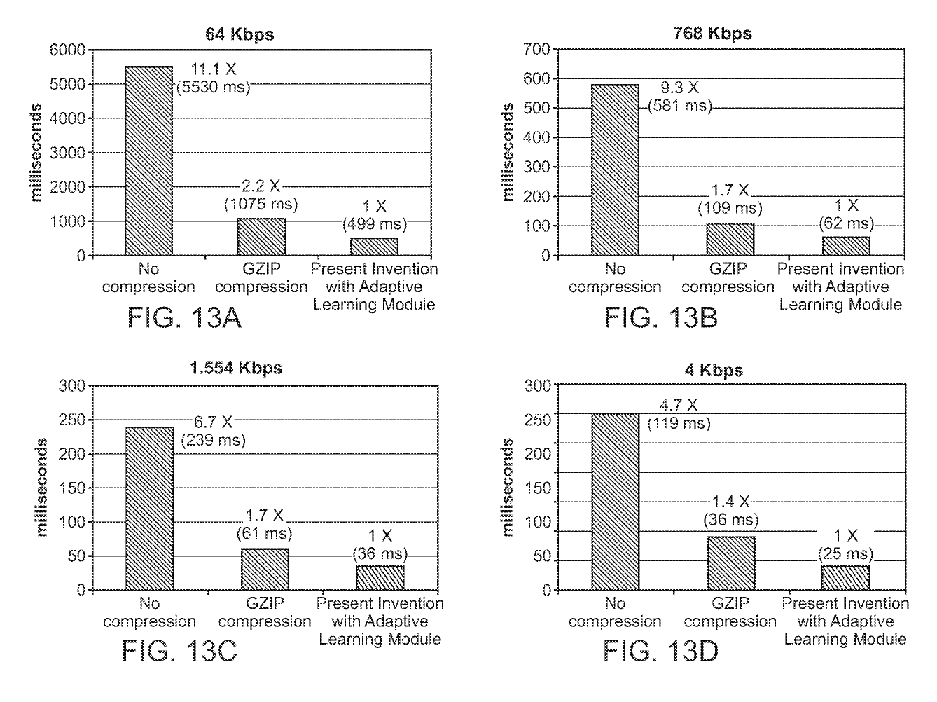

Twenty-five web pages were generated per search engine and downloaded separately to measure download time. Downloading was performed over the simulated WAN link set to a 64 Kbps bandwidth, and repeated for bandwidths of 768 Kbps, 1.554 Mbps, and 4 Mbps. Average download times are shown in the right-side column of FIGS. 13A-13D.

### TEST EXAMPLE 2

The test setup and procedure of Test Example 1 was used except GZIP compression was used. GZIP compression is a conventional means of compression found in HTTP 1.1-based browsers and is available from <www.gzip.org>. Average download times for GZIP compression are shown in the center column of FIGS. 13A-13D. As indicated in FIGS. 12A-12D, HTML page download times for GZIP compression are between 1.4 to 2.2 times that of download times with compression according to the present invention.

### TEST EXAMPLE 3

The test setup and procedure of Test Example 1 was used except no compression was used. Average download times for no compression are shown in the left-side column of FIGS. 13A-13D. As indicated in FIGS. 13A-13D, HTML page download times for no compression are between 4.7 to 11.1 times that of download times with compression according to the present invention.

### TEST EXAMPLE 4

The test setup of Test Example 1 was used except a second PC 1208 connected to the Ethernet network simulator 1206 was running WIRESHARK© Network Protocol Analyzer v0.99.6a, an open source network packet analyzer available from <www.wireshark.org>. The total bytes transferred was calculated from network captures using the WIRESHARK software.

The 1,016 web pages stored on the web server 1202 for each search engine were individually compressed with GZIP and according to the present invention with an adaptive learning module. The final size of the compressed pages, compression ratio, and factor gain over GZIP are shown in TABLE 1. As indicated in TABLE 1, the factor gain or improvement of compression according to the present invention is 1.5 to 2.5 times over GZIP, depending on the search engine.

| | Search Engine | | | | | | | | | |
|---|---|---|---|---|---|---|---|---|---|---|
| | AOL | | Ask | | Google | | MSN | | Yahoo | |
| | | Invention | | Invention | | Invention | | Invention | | Invention |
| | | with | | with | | with | | with | | with |
| | | Adaptive | | Adaptive | | Adaptive | | Adaptive | | Adaptive |
| | | Learning | | Learning | | Learning | | Learning | | Learning |
| Compression | GZIP | Module | GZIP | Module | GZIP | Module | GZIP | Module | GZIP | Module |
| Total | 9,343 | 5,171 | 13,912 | 9,122 | 5,818 | 2,435 | 9,076 | 3,710 | 9,614 | 5,129 |
| Compressed | | | | | | | | | | |
| Size (Kb) | | | | | | | | | | |
| Raw File | 38,073 | 38,073 | 84,423 | 84,423 | 20,844 | 20,844 | 30,236 | 30,236 | 42,496 | 42,496 |
| Size (Kb) | | | | | | | | | | |
| Compression | 4:1 | 7:1 | 6:1 | 9:1 | 4:1 | 9:1 | 3:1 | 8:1 | 4:1 | 8:1 |
| Ratio | | | | | | | | | | |
| Factor Gain | — | 1.8× | — | 1.5× | — | 2.4× | — | 2.5× | — | 1.9× |
| over GZIP | | | | | | | | | | |

IV. Method of Providing Service to Consumers

In one embodiment of the present invention, a system may be provided to companies or individuals to speed up the delivery rate of their website to the client. For example, the system may be provided to a web search based business. The use of the present invention would allow for the business to provide search results to the client at a faster rate. In addition, this service can be provided to other sites and a web search result from the web based business could indicate that the other sites have this system.

A method in accordance with aspects of the invention will now be described. The method comprises offering a business entity an ability to transfer electronic data to a client that is faster than the business entity's existing ability to transfer electronic data. Examples of electronic data include without limitation web page presentation information, such as hypertext markup language (HTML), Javascript, cascading style sheets (CSS), other scripting and style sheet languages. Other examples of electronic data include, without limitation, documents in portable document format (PDF), word processing files, graphics files, video files, audio files and multimedia files.

In some embodiments, the method further comprises providing an indicator on a web search result page, the indicator indicating that the business entity has the ability to transfer electronic data to the client at the speed that is faster. The indicator can be displayed on the client device. For example, the indicator can be displayed adjacent a web search result hyperlink that is associated with the business entity.

In other embodiments, the method further comprises providing a codec to the business entity for use in either one or both of compressing and decompressing electronic data. In further embodiments, the the codec includes one or both of an adaptive progression pattern and a logical frequency lexicon.

Another method in accordance with aspects of the invention will now be described. The method comprises offering an individual an ability to obtain web search results faster than the individual's existing ability to obtain web search results. The offer may indicate that a codec is available for downloading by the individual that would give the ability to obtain faster web search results. The codec includes one or both of an adaptive progression pattern and a logical frequency lexicon. The codec may be part of a plug-in program adapted to interact with a web browser, graphics software, e-mail client, media player, or other host component running on a client device operated by the individual.

In the foregoing specification, the invention has been described with reference to specific embodiments. However, it may be appreciated that various modifications and changes can be made without departing from the scope of the present invention as set forth in the claims below. It is also contemplated that various combinations or subcombinations of the specific features and aspects of the disclosed embodiments can be combined with or substituted for one another in order to form varying modes of the invention. Accordingly, the specification and figures are to be regarded in an illustrative rather than restrictive sense, and all such modifications are intended to be included within the scope of the present invention.

What is claimed is:

1. A system for electronic delivery of data, comprising an encoder adapted to receive input data, compress the input data in accordance with a model, and generate delivery data from the compressed input data.

2. The system of claim 1, further comprising a decoder adapted to reside in a client device and receive the delivery data, decompress the received delivery data in accordance with the model, and generate decompressed output data from the decompressed delivery data, the decompressed output data representing the input data.

3. The system of claim 1, wherein the encoder is part of a server or distributed over a group of servers.

4. The system of claim 1, further comprising a module adapted to modify the model.

5. The system of claim 2, wherein the decompressed output data includes all of the input data without loss.

6. The system of claim 1, wherein the input data and the decompressed output data include web page presentation information.

7. The system of claim 1, wherein the encoder includes a data analyzer adapted to identify data elements of the input data and determine a characteristic of each of the data elements, the characteristic being one or a combination of whether the data element is encoded, whether the data element is capable of being transcoded, whether the data element is text, and whether the data element is hybrid content that was dynamically generated.

8. The system of claim 7, wherein the encoder further includes a protocol decision module in communication with the data analyzer and adapted to calculate a file size of at least one of the data elements and calculate an available bandwidth for communicating with the client device, and further adapted to provide a first indicator, based at least on the calculated file size and the calculated available bandwidth, on whether compression should be performed on the data element, the first indicator being positive when a throughput time gain is likely to be greater than the sum of compression time and decompression time.

9. The system of claim 1, wherein the encoder includes a protocol decision module adapted to calculate a file size of the input data and calculate an available bandwidth for communicating with the client device, and further adapted to provide an indicator, based at least on the calculated file size and the calculated available bandwidth, on whether compression should be performed.

10. The system of claim 9, wherein the protocol decision module is further adapted to make the indicator positive on condition that the calculated file size is within a pass-through file size range.

11. The system of claim 10, wherein the protocol decision module is further adapted to determine the pass-through file size range based at least on the calculated available bandwidth.

12. The system of claim 10, wherein the protocol decision module is further adapted identify a bandwidth bin based on the calculated available bandwidth, and select the pass-through file size range from a plurality of ranges based on the identified bandwidth bin.

13. The system of claim 12, wherein the protocol decision module is adapted to identify the bandwidth bin from a plurality of bins, the bins corresponding to bandwidth ranges available in different geographic regions, at least one of the bandwidth ranges accounting for an average network connection availability in a particular geographic region.

14. The system of claim 10, wherein the protocol decision module is further adapted to determine the pass-through file size range based at least on an average network availability in a particular geographic region.

15. The system of claim 9, wherein the protocol decision module is further adapted to provide, on condition that the calculated file size is within the pass-through file size range, a compression ratio and a compression speed that are capable of delivering a positive throughput time gain.

16. The system of claim 9, wherein the protocol decision module is further adapted to provide, on condition that the calculated file size is within the pass-through file size range, a compression ratio and a compression speed that are capable of delivering a throughput time gain that is greater than or equal to the sum of compression time and decompression time.

17. The system of claim 8, wherein the encoder further includes a compression decision module in communication with the protocol decision module and adapted to calculate an estimated throughput time with compression (“T1”) and an estimated throughput time without compression (“T2”), and provide a second indicator on whether compression should be performed, the second indicator being positive when T1 is less than T2, wherein T1 is determined from CR/BW+CT+DT, where CR is the compression ratio, BW is the calculated available bandwidth, CT is compression time, and DT is decompression time, and wherein T2 is determined from FS/BW, where FS is the calculated file size of the data element.

18. The system of claim 1, wherein the encoder includes a compression decision module adapted to calculate an estimated throughput time with compression (“T1”) and an estimated throughput time without compression (“T2”), and provide an indicator that compression is needed on condition that T1 is less than T2.

19. The system of claim 18, wherein T1 is determined from CR/BW+CT+DT, where CT is compression time, DT is decompression time, BW is a bandwidth available to a client in need of the decompressed output data, and CR is a compression ratio.

20. The system of claim 18, wherein T2 is determined from FS/BW, where FS is a file size of the input data and BW is an available bandwidth for communicating with the client device.

21. The system of claim 17, wherein the encoder further includes a compression module in communication with the protocol decision module and the compression decision module, the compression module including a plurality of compression engines adapted to compress the input data, the compression module adapted to select a compression engine from among the plurality of compression engines, the selected compression engine selected based at least on the first indicator, the compression ratio, the compression speed, and the second indicator.

22. The system of claim 21, wherein the encoder further includes an adaptive learning module adapted to modify at least one of the plurality of compression engines.

23. The system of claim 1, wherein the encoder includes a compression module including a plurality of compression engines and is adapted to select a compression engine from among the plurality of compression engines based at least on the contents of the input data.

24. The system of claim 23, wherein the selected compression engine is selected based at least on a characteristic of the input data, the characteristic being one or a combination of entropy level, size, whether the input data includes text, and whether the input data includes static content, whether the input data includes dynamic content, whether the input data includes homogenous content, and whether the input data includes hybrid content.

25. The system of claim 1, wherein the encoder is further adapted to compress the input data using a compression engine, and the encoder further includes an adaptive learning module adapted to update the compression engine.

26. The system of claim 25, wherein the adaptive learning module is adapted to update the compression engine when a performance statistic falls below a performance threshold, the performance statistic being one or a combination of a compression ratio, an estimated throughput time with compression, and an historical trend in estimated throughput time with compression.

27. The system of claim 26, wherein the compression engine includes a current pattern or lexicon and is adapted to receive two data samples, generate a refined sample based on tag information and other web page presentation information common to the two received data samples, generate a new pattern or lexicon from the refined sample, replace the current pattern or lexicon with the new pattern or lexicon on condition that an estimated similarity between the current and new patterns or lexicons is greater than a similarity threshold.

28. The system of claim 26, wherein the compression engine includes a current pattern or lexicon and the adaptive learning module is further adapted to perform a process that generates a new refined sample from two data samples, one of the two data samples being an immediately previous refined sample, the process recursively repeated until the newest refined sample and the immediately previous refined sample have a difference that is below a difference threshold, the adaptive learning module adapted to generate a new pattern or lexicon from the newest refined sample and replace the current pattern or lexicon with the new pattern or lexicon.

29. The system of claim 26, wherein the compression engine includes a current pattern or lexicon, and the adaptive learning module is further adapted to obtain samples of the input data, remove from each of the obtained samples information that is common among the samples, remove from each of the samples redundant or recurring words to create refined samples containing unique words, generate a frequency ranking of each refined samples based at least on a number of words matching a master natural language logical frequency lexicon, generate a new pattern or lexicon from the refined sample having the highest frequency ranking, and replace the current pattern or lexicon with the new pattern or lexicon.

30. The system of claim 26, wherein the compression engine includes a current pattern or lexicon, and the adaptive learning module is further adapted to obtain samples of the input data, remove from each of the obtained samples information that is common among the samples, remove from each of the samples redundant or recurring words to create refined samples containing unique words, generate an aggregated sample from the sum of the refined samples, generate a new pattern or lexicon from the aggregated sample, and replace the current pattern or lexicon with the new pattern or lexicon.

31. The system of claim 2, wherein the decoder is includes a decompression module adapted to decompress the delivery data and an update module adapted to update the decompression module.

32. The system of claim 2, wherein the delivery data includes one or more parameters indicating compression mode and target area, the compression mode being any of adaptive progression pattern-based compression and logical frequency lexicon-based compression, the target area being any of e-mail, content management, web content, and online collaborative environment, and wherein the decoder includes a header analyzer adapted to determine the status of the parameters.

33. The system of claim 32, wherein the decoder further includes a plurality of decompression modules adapted to decompress the delivery data and a decompression decision logic adapted to select a decompression module from among the plurality of decompression modules, the selected decompression module selected based on the determined status of the parameters.

34. A method for electronic delivery of data, comprising:
compressing the input data in accordance with a model;
generating delivery data from the compressed input data; and
sending the delivery data to a client device

35. The method of claim 34, further comprising:
receiving the sent delivery data at the client device;
decompressing the received delivery data; and
generating decompressed output data from the decompressed delivery data and the model;
wherein the decompressed output data represents the input data.

36. The method of claim 34, further comprising modifying the model.

37. The method of claim 35, wherein the decompressed output data includes all of the input data without loss.

38. The method of claim 34, wherein the input data and the decompressed output data include web page presentation information.

39. The method of claim 34, further comprising determining a characteristic of a data element of the input data, the characteristic being one or a combination of whether the data element is encoded, whether the data element is capable of being transcoded, whether the data element is text, and whether the data element is hybrid content that was dynamically generated.

40. The method of claim 39, further comprising determining whether to compress the data element based at least on the determined characteristic of the data element.

41. The method of claim 39, wherein the compressing includes selecting a compression mode from among a plurality of compression modes and compressing the data element in accordance with the selected compression mode, the selecting based at least one the determined characteristic of the data element.

42. The method of claim 39, further comprising:
calculating a file size of the data elements;
calculating an available bandwidth for communicating with the client device;
providing a first indicator, based at least on the calculated file size and the calculated available bandwidth, on whether compression should be performed on the data element, the first indicator being positive when a throughput time gain is likely to be greater than the sume of compression time and decompression time;
wherein the compressing is performed when the first indicator is positive.

43. The method of claim 34, further comprising:
calculating a file size of the input data;
calculating an available bandwidth for communicating with the client device;
providing an indicator, based at least on the calculated file size and the calculated available bandwidth, on whether compression should be performed.

44. The method of claim 43, wherein providing the indicator includes making the indicator positive on condition that the calculated file size is within a pass-through file size range.

45. The method of claim 44, further comprising determining the pass-through file size range based at least on the calculated available bandwidth.

46. The method of claim 44, further comprising identifying a bandwidth bin based on the calculated available bandwidth, and selecting the pass-through file size range from a plurality of ranges based on the identified bandwidth bin.

47. The method of claim 46, wherein the identifying the bandwidth bin includes identifying the bandwidth bin from a plurality of bins, the bins corresponding to bandwidth ranges available in different geographic regions, at least one of the bandwidth ranges accounting for an average network connection availability in a particular geographic region.

48. The method of claim 44, further comprising determining the pass-through file size range based at least on an average network availability in a particular geographic region.

49. The method of claim 43, further comprising providing, on condition that the calculated file size is within the pass-through file size range, a compression ratio and a compression speed that are capable of delivering a positive throughput time gain.

50. The method of claim 43, further comprising providing, on condition that the calculated file size is within the pass-through file size range, a compression ratio and a compression speed that are capable of delivering a throughput time gain that is greater than or equal to the sum of compression time and decompression time.

51. The method of claim 34, further comprising:
calculating an estimated throughput time with compression (“T1”);
calculating an estimated throughput time without compression (“T2”); and
providing a second indicator on whether compression should be performed, the second indicator being positive when T1 is less than T2, wherein T1 is determined from CR/BW+CT+DT, where CR is the compression ratio, BW is the calculated available bandwidth, CT is compression time, and DT is decompression time, and wherein T2 is determined from FS/BW, where FS is the calculated file size of the data element;
wherein the compressing is performed when the second indicator is positive.

52. The method of claim 34, further comprising selecting a compression engine from a plurality of compression engines based at least on the contents of the input data.

53. The method of claim 52, wherein the selected compression engine is selected based at least on a characteristic of the input data, the characteristic being one or a combination of entropy level, size, whether the input data includes text, and whether the input data includes static content, whether the input data includes dynamic content, whether the input data includes is homogenous content, and whether the input data includes hybrid content.

54. The method of claim 34, further comprising updating a compression engine, and wherein the compressing includes using the compression engine to compress the input data.

55. The method of claim 54, further comprising:
comparing a performance statistic against a performance threshold, the performance statistic being one or a combination of a compression ratio, an estimated throughput time with compression, and a historical trend in estimated throughput time with compression,
wherein the updating is performed when the performance statistic falls below the performance threshold.

56. The method of claim 54, wherein the compression engine includes a current pattern or lexicon for compressing the input data and the updating includes:
receiving two data samples;
generating a refined sample based on tag information and other web page presentation information common to the two received data samples;
generating a new pattern or lexicon from the refined sample;
replacing the current pattern or lexicon with the new pattern or lexicon on condition that an estimated similarity between the current and new patterns or lexicons is greater than a similarity threshold.

57. The method of claim 54, wherein the compression engine includes a current pattern or lexicon for compressing the input data and the updating includes:
performing a process that generates a new refined sample from two data samples, one of the two data samples being an immediately previous refined sample, recursively repeating the process until the newest refined sample and the immediately previous refined sample have a difference that is below a difference threshold;
generating a new pattern or lexicon from the newest refined sample; and
replacing the current pattern or lexicon with the new pattern or lexicon.

58. The method of claim 54, wherein the compression engine includes a current pattern or lexicon for compressing the input data and the updating includes:
obtaining samples of the input data;
creating refined samples containing unique words, including removing from each of the obtained samples information that is common among the samples, and removing from each of the samples redundant or recurring words;
generating a frequency ranking of each refined samples based at least on a number of words matching a master natural language logical frequency lexicon;
generating a new pattern or lexicon from the refined sample having the highest frequency ranking; and
replacing the current pattern or lexicon with the new pattern or lexicon.

59. The method of claim 54, wherein the compression engine includes a current pattern or lexicon for compressing the input data and the updating includes:
obtaining samples of the input data;
creating refined samples containing unique words, including removing from each of the obtained samples information that is common among the samples, and removing from each of the samples redundant or recurring words;
generating an aggregated sample from the sum of the refined samples;
generating a new pattern or lexicon from the aggregated sample; and
replacing the current pattern or lexicon with the new pattern or lexicon.

60. The method of claim 35, further comprising:
adding one or more parameters to the delivery data prior to sending the delivery data, the one or more parameters indicating compression mode and target area, the compression mode being any of adaptive progression pattern-based compression and logical frequency lexicon-based compression, the target area being any of e-mail, content management, web content, and online collaborative environment; and
determining the status of the parameters at the client device.

61. The method of claim 60, wherein the decompressing includes:
selecting a decompression module from a plurality of decompression modules adapted to decompress the delivery data, the selecting based on the determined status of the parameters.

62. A method of conducting business, comprising:
offering a business entity an ability to transfer electronic data to a client that is faster than the business entity's existing ability to transfer electronic data; and
providing an indicator on a web search result page, the indicator indicating that the business entity has the ability to transfer electronic data to the client at the speed that is faster.

63. The method of claim 62, further comprising providing a codec to the business entity for use in either one or both of compressing and decompressing electronic data.

64. The method of claim 62, wherein providing the indicator includes displaying the indicator on the client device.

65. The method of claim 62, further comprising giving a license to the business entity to use a codec for use in either one or both of compressing and decompressing electronic data.

66. The method of claim 62, wherein the electronic data includes web page presentation information.

67. The method of claim 62, wherein the codec includes one or both of an adaptive progression pattern and a logical frequency lexicon.

68. A method of decreasing download time for search results, comprising:
offering an individual an ability to obtain web search results faster than the individual's existing ability to obtain web search results;
allowing the individual to download a codec that includes one or both of an adaptive progression pattern and a logical frequency lexicon.

69. The method of claim 68, wherein allowing the individual to download a codec includes allowing the individual to download a web browser plug-in.
